(19) United States
(12) Patent Application Publication
(10) Pub. No.: US 2022/0284360 A1
(43) Pub. Date: Sep. 8, 2022

(54) ENHANCED TRACKING OF QUARRY AND MINING MACHINE OPERATION

(71) Applicant: Caterpillar Inc., Peoria, IL (US)

(72) Inventors: Chad T. Brickner, Peoria, IL (US); Nicholas A. Hanauer, Peoria, IL (US); Timothy E. Noon, Peoria, IL (US); Vishnu Gaurav Selvaraj, Tamil Nadu (IN); Bradley K. Bomer, Peoria, IL (US); Allen J. DeClerk, Peoria, IL (US); Eric J. Spurgeon, Peoria, IL (US); Arun P. Alayamani, Peoria, IL (US)

(21) Appl. No.: 17/194,048

(22) Filed: Mar. 5, 2021

(51) Int. Cl. G06Q 10/06; G06F 16/29; G06F 16/26; G06Q 50/02

(52) U.S. Cl. CPC G06Q 10/0633; G06F 16/29; G06F 16/26; G06Q 10/0639; G06Q 50/02

(57) ABSTRACT

Enhanced tracking of quarry and mining machine operation is described herein. The method and system generate productivity metrics for a production asset cycle that comprises a plurality of serially connected segments. More particularly the method includes acquiring a production data point associated with a mobile asset. The method further includes assigning a temporal production status to the data point based upon the temporal instance data and at least one of a supplemental production data taken from the group consisting of: a current zone within a worksite occupied by the mobile asset, a machine state reported by the mobile asset, and a time-correlated production cycle-segment status of a further mobile asset interacting with the mobile asset. The disclosure provides, in another aspect, a method for visualizing aggregated production events for a mobile asset operated within a repeating production cycle comprising a plurality of serially connected segments.

### CROSS-REFERENCE TO RELATED PATENT APPLICATIONS

The present application claims priority to U.S. Provisional Patent Application No. 62/986,469, filed Mar. 6, 2020, which is hereby incorporated by reference in its entirety.

### TECHNICAL FIELD

This patent disclosure relates generally to mining and aggregate material handling, and, more particularly to a system and method for generating and presenting operation summaries of operation and production associated with work site assets of a quarry and/or mining operation.

### BACKGROUND

To produce construction materials at a worksite (e.g. a quarry), raw materials are excavated from the ground at a first location and transported to a second location for temporary storage/stockpiling before further processing and transport to another location within site or off site. Machines associated with the transport and handling of the excavated materials operate in repeated cycles. During each cycle, a set of sequential connected segments are performed.

Today, mining and quarry worksite machinery are equipped with telematics transponders that periodically transmit timestamped location indication messages (including a machine/source identification) to a receiving server. Such information has been used to generate productivity/utilization information for individual machines operating at the worksite. One way such information may be used is to generate a cycle count and average cycle time for individual machines. However, even more detailed analysis may render statistical information regarding identifiable portions (i.e., segments) of the cycle performed by an individual machine.

Traditionally, back-end processing on accumulated telematics data sets for multiple, interoperating, machines (e.g. a loader and a dump truck) are processed together to render even more detailed information regarding the aforementioned portions of the cycle. For example, when two machines proximity is within a certain threshold distance, they are deemed to be productively interacting (e.g., the loader is filling the dump truck with material). However, proximity alone may not provide an accurate indication of productive interaction between the two machines (also referred to herein as “assets”). For example, if one of the two machines must be turned on to carry out productive activity, then productive activity should not be registered when that machine is turned off—even though the proximity of the two machines suggests productive interaction. Additionally, if the two machines are not located in an area where productive activity is not possible (e.g. a machine maintenance building), then proximity alone is insufficient to indicate productive interaction.

Moreover, a constant challenge exists to present accumulated data points and resulting segment event instances in a meaningful way. For example, based upon the type of information sought by a user, presentation of a number of executed segments at a particular site location may convey an inaccurate view of productivity and/or effective utilization of site assets (e.g. haulers, loaders, etc.).

The present disclosure is directed to a system and method for generating enhanced productivity metrics that more accurately present, in an easily consumed form, productivity and utilization of mobile assets at a worksite.

### SUMMARY

The disclosure provides, in one aspect, a method for generating productivity metrics for a production asset cycle that comprises a plurality of serially connected segments. More particularly the method includes acquiring a production data point associated with a mobile asset. The production data point comprises a temporal instance data including: a timestamp, a geospatial location, and an asset identification corresponding to the mobile asset. The method further includes assigning a temporal production status to the data point based upon the temporal instance data and at least one of a supplemental production data taken from the group consisting of: a current zone within a worksite occupied by the mobile asset, wherein the current zone is determined by applying the geospatial location to a user-defined worksite zone definition comprising a set of non-overlapping geospatially defined zones within the worksite, a machine state reported by the mobile asset, and a time-correlated production cycle-segment status of a further mobile asset interacting with the mobile asset.

The disclosure provides, in another aspect, a method for visualizing aggregated production events for a mobile asset operated within a repeating production cycle comprising a plurality of serially connected segments. The method includes configuring a user-defined worksite zone definition comprising a set of non-overlapping geospatially defined zones within the worksite. The method further includes accumulating a set of production data points associated with the mobile asset, wherein one or more of the set of production data points comprise a temporal instance data including: a timestamp, a geospatial location, an asset identification corresponding to the mobile asset. The method also includes determining a set of segment event instances from the set of production data points, wherein each one of the set of segment event instances is assigned a segment type from a set of segment types represented in the repeated production cycle. The method further includes assigning a segment event location to one or more of the set of segment event instances. A site map is presented of the worksite overlaid with the set of non-overlapping geospatially defined zones. The set of segment event instances are presented, according to the assigned segment event locations, on the site map of the worksite.

### BRIEF DESCRIPTION OF THE DRAWINGS

FIG. 1 schematically depicts (in simplified form) a worksite, such as a quarry, in which mining equipment such as loaders, dump trucks and haulers operate according to repeating cycles comprising a set of sequential segments in accordance with an aspect of the disclosure.

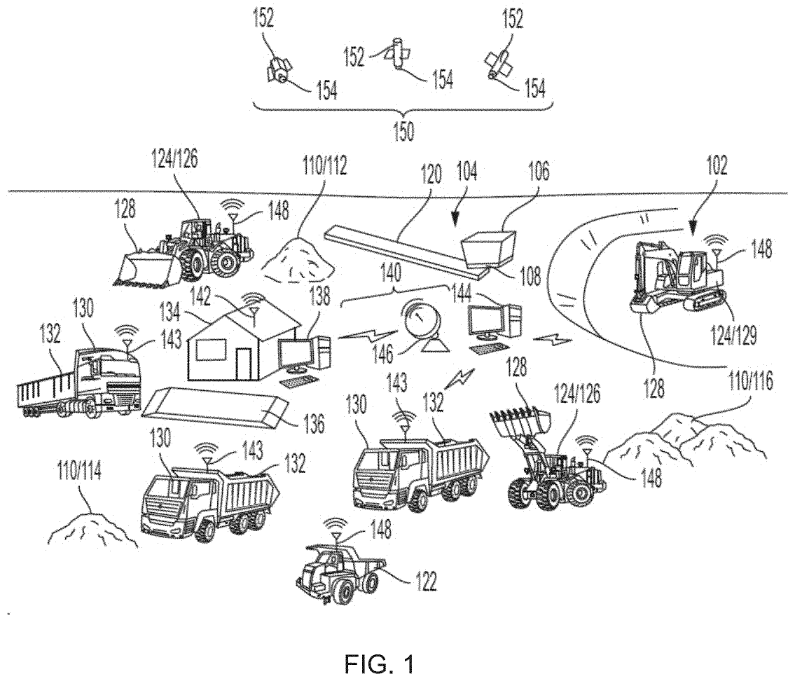

FIG. 2 illustratively depicts an exemplary data format of a production data point including temporal instance data.

FIG. 3 illustratively depicts a flow of production data points from mobile asset at a worksite to a storage location within a database in accordance with an aspect of the disclosure.

FIG. 4 illustratively depicts a graphical user interface view that facilitates configuring a worksite map comprising a set of non-overlapping geospatially defined zones.

FIG. 5 provides an exemplary graphical user interface for visualizing productivity of a selected asset in accordance with the disclosure.

FIGS. 6A, 6B, and 6C provide a series of productivity visualization application user interfaces/views that graphically depict production segment events (in grouped and ungrouped form) within a graphical view that is overlaid with the above-discussed user-defined zones.

FIG. 7 is a flowchart summarizing a set of operations that are carried out by, for example, the production event data processing system to render a temporal production status (productivity state) on a production data point for purposes of generating productivity metrics for a production asset cycle of the source asset of the production data point.

FIG. 8 is a flowchart summarizing a set of operations associated with visualizing (per FIGS. 6A, 6B, and 6C) aggregated production events for a mobile asset operated within a repeating production cycle comprising a plurality of serially connected segments

### DETAILED DESCRIPTION

Now referring to the drawings, wherein whenever possible like reference numbers will refer to like elements, there is illustrated a worksite 100 such as a quarry for the exaction, processing, storage, and delivery of mined materials such as construction aggregates, mineral ores, and the like. Examples of these materials include stone, sand, sandstone, chalk, clay, coal, iron ore, copper ore, gypsum, etc. Various different operations, tasks, and processes may be conducted at different geospatially parts of the worksite 100.

By way of example, to obtain the raw materials, the worksite 100 may be associated with one or more mines 102, which is the location where the raw materials are excavated from the ground. The mine 102 may be a surface mine in which the overburden (vegetation, dirt, and the like) is stripped away and removed to access the raw materials underneath. The raw materials may be separated from the ground by drilling, hammering, or blasting operations and removed from the mine 102. In other examples, the mine 102 may be a subsurface or underground mine in which tunnels are dug to access the raw materials. In possible examples, the mine 102 may be located onsite at the worksite 100 or may be located a significant distance from other the areas of the worksite. Once obtained from the mine 102, the raw materials may be directed through various processes conducted by different processing equipment 104. For example, to break or fragment the raw materials into smaller sizes or grades, the raw materials may be directed through one or more crushers 106 that may include intermeshing gears or jaws, or that may be impact hammer crushers. The crusher 106 may be operatively associated with a screen 108 that separates larger and smaller sizes or grades by allowing the finer materials to pass through while retaining larger sizes. Various other types of processing equipment 104 may be employed to refine the raw materials to have desired qualities.

The processed materials (e.g., in aggregate or granular form) may be disposed in various piles 110 about the worksite 100 until the processed materials have been sold and transported from the worksite. In some cases, the piles 110 are designated and separated by material type, grade, and/or other characteristics based on the availability of the processed materials in different sizes or grades, and different types of material (e.g., stone and sand) can be obtained from the mine 102. Physical separation between the piles 110 can be maintained to preserve the homogeneity of an individual material in the pile. In addition, the piles 110 may be located at significant distances from each other, for example, due to the location of the processing machinery, (e.g. crusher 106 and screen 108), or due to the location within the mine 102 or among different mines from which the materials are obtained. In addition, the piles 110 may be placed in different zones or areas within the worksite 100 depending upon the type of material available (e.g., limestone verses sand) or the type of processing equipment 104 associated with the zone. Each zone in the worksite 100 can include one or more piles 110. For example, there is a first pile location 112 having one type or grade of material, a second pile location 114 having a different type or grade of material, and a third pile location 116 having another different type or grade of material 118.

To transport the materials from the mines 102 and the processing equipment 104 to the piles 110, the worksite 100 may be operatively associated with various machines such as, for example, a belt conveyor 120 which extends for substantial distances. In addition, one or more haul trucks 122, which may be large-sized off road trucks with opened dump bodies, can transport material about the worksite 100. To physically move or manipulate material in the piles 110, a plurality of loading machines 124 can be operatively associated with the worksite 190. Examples of loading machines 124 include a bucket loader 126 which includes a bucket 128 and which may be supported on wheels or, in an embodiment, continuous tracks to propel the bucket loader about the worksite. The bucket 128 can be mounted to the front of the bucket loader 126 on booms or arms so that the bucket 128 can be articulated through lifting and dumping motions. To provide power, the bucket loader 126 can also include a fuel combusting engine such as a diesel engine and to maneuver the bucket 128 the loader can be associated with a hydraulic system. Another example of a loading machine 124 is an excavator 129 that can include a bucket 128 disposed at the end of a mechanical linkage that can articulate with respect to itself to maneuver the bucket 128.

The worksite 100 may be associated with additional zones or areas responsible for performing specific operations associated with the extraction, processing, storage, and delivery of material. For example, to remove the material from the worksite 100 and transport it to an end use such as a construction site, customers or other responsible entities may send one or more road trucks 130 that are configured to haul the material. The road trucks 130 may include a dump body 132 or a similar structure that can hold the material. The dump body 132 may be an open topped structure to receive the material and may be tilted with respect to the rest of the road truck 130 to dump the material. The road trucks can be adapted to travel on highways or paved roads. When the road trucks 130 arrive at or depart from the worksite 100, they may encounter or pass through an entrance facility or a scale house 134, which may be a physical facility or location at the worksite 100. To weigh road trucks 130 departing from and/or entering the worksite 100, the scale house 134 is operatively associated with a large sized scale 136 that the road trucks can drive onto during measurement.

The entrance facility or scale house 134 can also provide accommodations for worksite personnel and road truck operators to exchange information and conduct transactions relating to the transportation of material from the worksite 100. To facilitate that exchange, the entrance facility or scale house 134 can be operatively associated with a front end system 138. The front end system 138 may be part of a larger worksite computer system 140 that may be configured as part of an enterprise network for monitoring and regulating the operations of the worksite 100. The front end system 138 can include physical components like processing devices or processors and input-output peripherals (e.g., keyboards, monitors, mice) that enables the entry of information and data in computer readable form. The front end system 138 can be responsible for entry and initial processing of data obtained when the road trucks 130 check in and check out when arriving and/or departing from the worksite 100. For example, in an embodiment, to establish wireless communication with the road trucks 130, the front end system 138 may be associated with a wireless transmitter/receiver 142 that can exchange radio wave communications with a similar transmitter/receiver 143 disposed on the road truck. The wireless communication can utilize any suitable technology standards or protocols such as Wi-Fi and Bluetooth. However, it is possible that parts of the exchange between the road trucks 130 and the scale house 134 associated with the front end system 138 can be accomplished through verbal exchanges or by exchanging traditional paperwork.

In addition to the front end system 138, to monitor and regulate other operations and information associated with the worksite 100, the worksite computer system 140 may be operatively associated with a backend system 144. The backend system 144 may be maintained by the owners/operators of the worksite 100, or may be maintained by an application service provider (“ASP”), through independent contractors or the like. Although in the illustrated embodiment, the functionality of the backend system 144 is depicted in a centralized manner, it may also be distributed over a plurality of computers and platforms networked together within the worksite computer system 140 and that may communicate and exchange information and data among various nodes. Like the front end system 138, the backend system 144 may include processing devices or processors and input-output peripherals for entry and processing of information and data in computer readable form and for the execution of software instructions and applications. The backend system 144 may also include data storage capabilities to store the software instructions and data in the form of random access memory or other volatile memory, read only memory or other permanent memory, or another suitable form of memory. The backend system 144 may be in operative communication via a network with the front end system 138 and with other computer systems associated with the worksite computer system 140. For example, the backend system 144 can be operatively associated with a telematics system 146 or the like that enables the backend system to communicate with the haul trucks 122 and the loading machines 124 operating about the worksite 100. Communication can occur wirelessly through radio waves if the haul trucks 122 and the loading machines 124 each including a wireless transmitter/receiver 148. Communication can also occur using any suitable protocol or standard such as Wi-Fi and Bluetooth and can occur over sufficient distances to cover the worksite 100. In addition to wireless communication, the backend system 144 may also include the functionality to communicate via conductive or optical lines.

In an embodiment, to determine the position of the haul trucks 122 and the loading machines 124 and possibly the road trucks 130 that may be moving about the worksite 100, the worksite may be operatively associated with a position determining system that may be implemented in any suitable form. For example, the position determining system can be realized as a global navigation satellite system (GNSS) or global positioning satellite (GPS) system 150. In the GNSS or GPS system 150, a plurality of manmade satellites 152 orbit about the earth at fixed or precise trajectories. Each satellite 152 includes a positioning transmitter 154 that transmits positioning signals encoding time and positioning information towards earth. By calculating, such as by triangulation, between the positioning signals received from different satellites, one can determine their instantaneous location on earth. In the present illustrative example, the transmitter/receiver 148 on the haul truck 122 and loading machines 124 and the transmitter/receivers 143 on the road trucks 130 receive the positioning signals from the positioning transmitter 154.

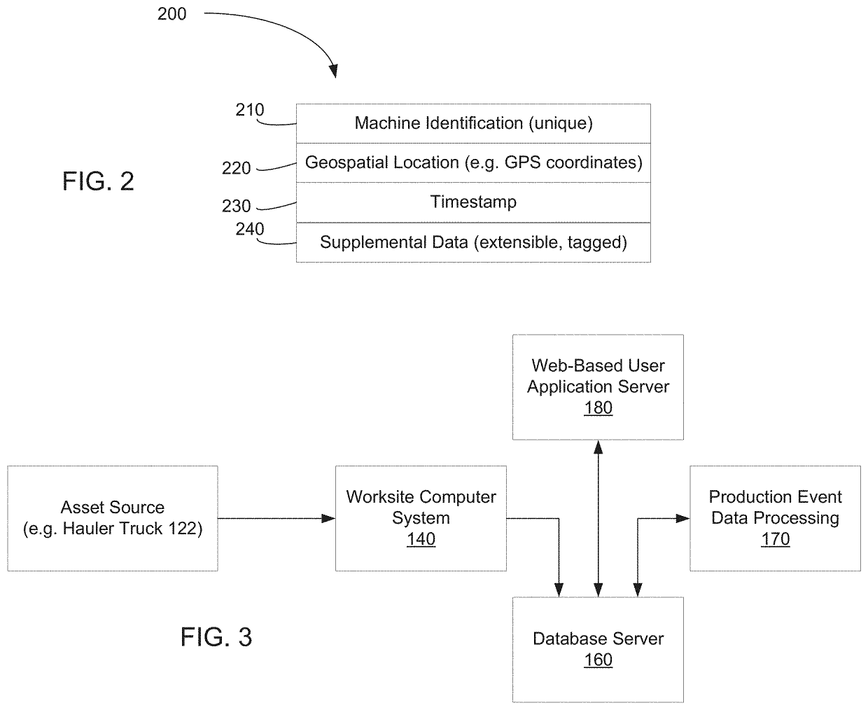

Referring to FIG. 2, an illustrative example data content of a production data point 200 is provided that includes a temporal instance data for an asset source (e.g. the haul truck 122). A machine identification 210 indicates the asset source associated with the production data point. The machine identification 210 comprises a unique value to identify the machine source associated with the production data point. The unique value can distinguish the source from all other asset sources for the worksite. A geospatial location 220 identifies with a high degree of precision (e.g. within several feet) a registered location of the asset source at an acquisition time indicated by a timestamp 230.

Additionally, in accordance with illustrative examples provided by the disclosure, the production data point 200 includes a supplemental data 240 comprising any of an extensible/configurable set of tagged supplemental data types. Examples of such supplemental data types may relate to machine state (e.g., engine on/off), tool/implement state (dump truck/hauler bed lift), transmission state (park, neutral, in-gear, etc.). In general, such machine state information is generated by various on-board sensors, actuators, and status transmitters on the asset source; and such data is received and processed by an onboard controller of the asset source (e.g. the hauler truck 122). By way of example, the supplemental data may include data provided by a payload monitoring system operatively associated with hauler truck 122 to measure current load weight and the like. Sensors may, for example, monitor load and dump cycles, and may monitor load weights through operative association with the hydraulic system to measure hydraulic forces generated during load and dump cycles or may utilize other force measurement technologies. The forgoing are merely examples of the types of information conveyed in the production data point 200.

Moreover, the illustrative depiction of the production data point 200 is not intended to limit the manner in which the information contained therein is packaged and transmitted by the asset source to, for example, the worksite computer system 140 (data gateway). For example, the asset source may generate several production data points over a period (e.g. 10 minutes), accumulate the production data points into a single composite message (in which case the machine identification 210 need only be provided once—for the entire set of production data points in the composite message), and transmit the composite message to the worksite computer system 140 for further processing.

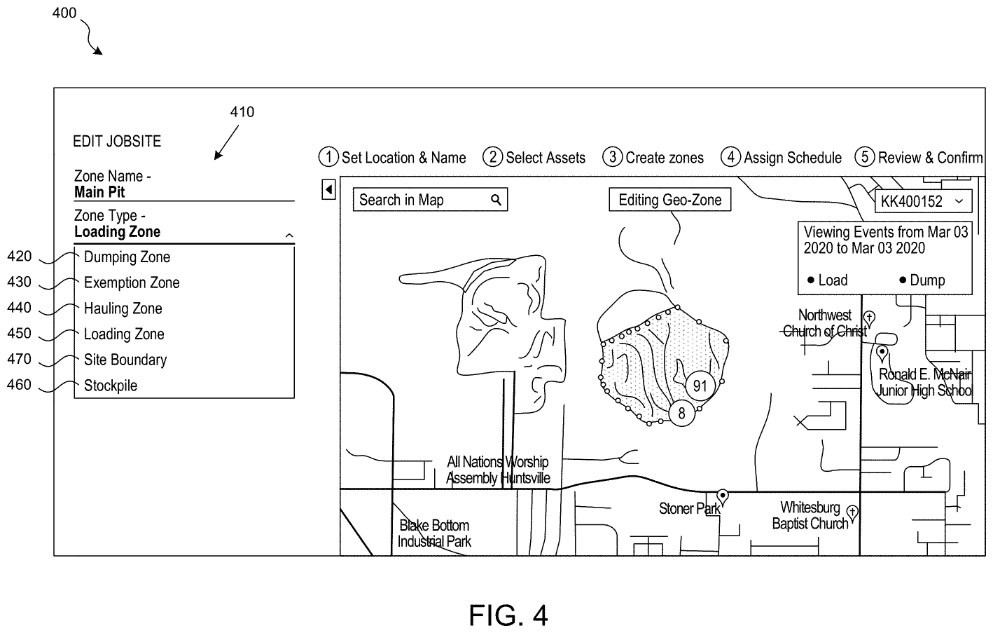

FIG. 3 illustratively depicts an exemplary production data point flow in accordance with the disclosure. In the illustrative example, the production data points are generated (including the aforementioned packaging in composite messages) and transmitted by an asset source, such as the haul truck 122, during execution of a production cycle. In a particular illustrative example, the asset source transmits a composite message to the worksite computer system 140 (e.g. a production data point gateway). In the illustrative example, the worksite computer system 140, configured as a data gateway, receives the packaged/composite messages from asset sources. The manner in which production data points are provided to the worksite computer system 140 will vary in accordance with alternative embodiments and examples consistent with the processing operations disclosed herein.

The received composite messages are digested by the worksite computer system 140 (gateway) and submitted as individual production data points to a database server 160. A production event data processing system 170 extracts and processes time sequences of the production data points to render enhanced production data summary information for presentation to users in accordance with the current disclosure. A Web server 180 thereafter provides user access to the information generated by the production event data processing system 170 via web site interfaces in accordance with the disclosure. The above described data flow and processing is provided by way of example and is not intended to limit the disclosure in any way to a particular networked computer configuration/architecture.

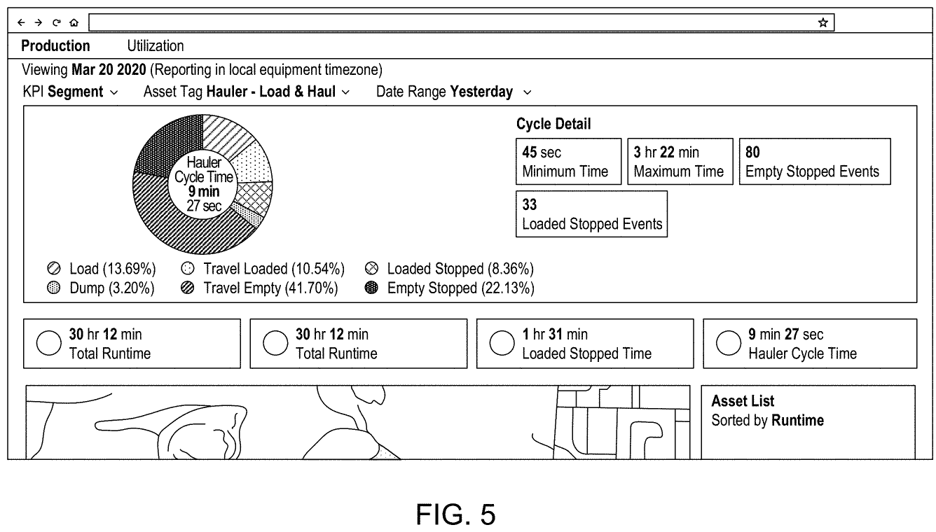

Having described the general environment and data processing that forms a platform for carrying out the disclosure contained herein, attention is directed to FIG. 4 that illustratively depicts a graphical user interface view 400 that facilitates configuring a worksite map comprising a set of non-overlapping geospatially defined zones. In particular, FIG. 4 shows a drop down list 410 that enumerates an exemplary set of assignable zone types. In the illustrative example, the listed selectable zones include: dumping 420, exemption (exclusion) 430, hauling 440, loading 450, and stockpile 460. A site boundary 470 selection tool enables a user to designate a spatial boundary of the worksite. Dumping zones designate a portion of the worksite where a hauler, such as the hauler truck 122 dumps a load. Loading zones designate a portion of the worksite where a hauler, such as the hauler truck 122 is loaded, for example, by a loader machine, such as the bucket loader 126. Exemption zones can identify portions of the worksite where a cycle time is suspended (e.g. re-fueling stations, parking lots, etc.).

In accordance with the illustrative example, after initially plotting a zone by sequentially plotting points along the perimeter using a plotting tool (resulting in a closed outline comprising a set of joined segments corresponding to the plot points) and thereafter selecting one of the zone types from the drop down list 410. The zone designation for a particular area (in accordance with illustrative examples provided herein), facilitates an enhanced view presentation as well as improved productivity computations/determinations generated by the production event data processing system 170 (in accordance with the disclosure). Upon completion, the user-defined zone is stored as the set of geospatial coordinates corresponding to the sequentially ordered (according to the user-entry during plotting) plot points. The entire plot point set is stored in a data structure including an appropriate field/label corresponding to the worksite and zone type (selected by the user during configuration of the zone from the provided drop down list). In some cases, line segments connecting plot points do not intersect other plot points for a zone—or any other zone. In other cases, line segments connecting plot points do intersect other plot points for a zone. The boundaries of different zones can overlap or not overlap.

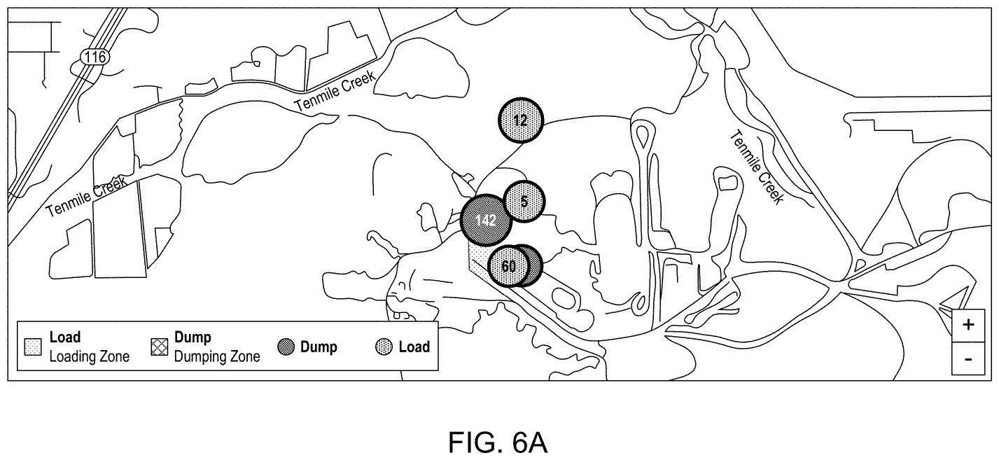

FIG. 5, in accordance with another aspect of the disclosure, provides an exemplary graphical user interface for visualizing productivity of a selected asset (e.g. the hauler truck 122). The illustrative user interface is provided to further illustrate the advances in current technology provided by the present disclosure. In particular, inaccurate determinations that an asset is operating in a particular one of the identified segments of a cycle (e.g. loading, dumping, traveling loaded, traveling empty, loaded stopped, and empty stopped) can skew and render less valuable the statistical production metrics presented in summary form in the illustrative view. For example, if the hauler truck 122 detours to a refueling station, then a current segment should be suspended during such detour. Similarly, if the hauler truck 122 is delayed because the bucket loader 126 is shut down or otherwise stopped loading during a loading stage of the hauler truck 122, then the load segment timer should be suspended as well.

The disclosure provided herein is aimed at improving the accuracy of the reported statistical values for a given asset (e.g. the hauler truck) through incorporation of additional types of supplemental production data. As will be further explained herein below, such supplemental production data includes one or more of the following: (1) a current zone within a worksite occupied by the mobile asset (hauler truck 122) —wherein the current zone is determined by applying the geospatial location to a user-defined worksite zone definition comprising a set of non-overlapping geospatially defined zones within the worksite; (2) a machine state reported by the mobile asset, and (3) a time-correlated production cycle-segment status of a further mobile asset interacting with the mobile asset.

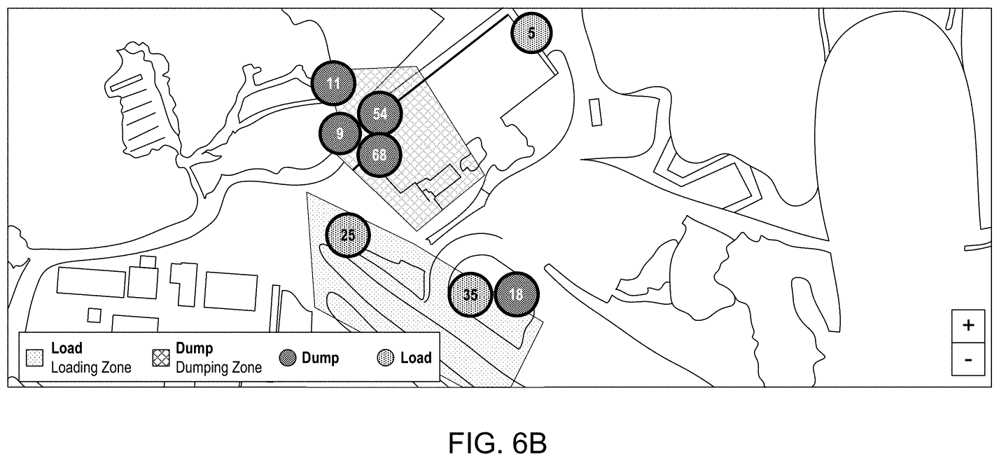

FIGS. 6A, 6B, and 6C, in accordance with another aspect of the present disclosure, provide a series of productivity visualization application user interfaces/views. More particularly, enhanced user visualization interfaces/views are provided that graphically depict production segment events (in grouped and ungrouped form) within a graphical view that is overlaid with the above-discussed user-defined zones. The inclusion of the zone indications provide insight as to exception events (e.g. a dumping of material in a non-dump zone such as an exemption zone or load zone). FIG. 6A is an exemplary “zoomed out” view is provided of a worksite with a series of numbered circles that indicate segment counts for particular segment types (color-coded) carried out by a particular asset (e.g. the hauler truck 122). More particularly, each number represents the instances of a segment event type that occurred within (i.e. located in) a generally same location (according to a specified distance parameter). Additionally, the system generates for display upon user request (e.g. a pop-up menu) a count of all instances of a segment event type that occurred (i.e. are located within) a particular one of the above-discussed user-configured zones. Thus, all dumping segments carried out by the particular asset, which are identified to have occurred within a dump zone, are grouped/counted and presented with a segment color-encoded circuit that displays the segment count within the particular zone for the particular asset. FIG. 6B is a partially zoomed in view that provides a view of the accumulated segment event counts falling within particular zones. FIG. 6C is a fully zoomed in view where a set of grouped segment instances, previously represented by a numbered (color-coded) circle containing an event instance count presented therein, are individually depicted as color-coded circles according to their associated segment event type. In each view, the zone is predominantly displayed to provide immediate visual context to the aggregated (FIGS. 6A and 6B) and non-aggregated (FIG. 6C) views of segment instances within particular zones.

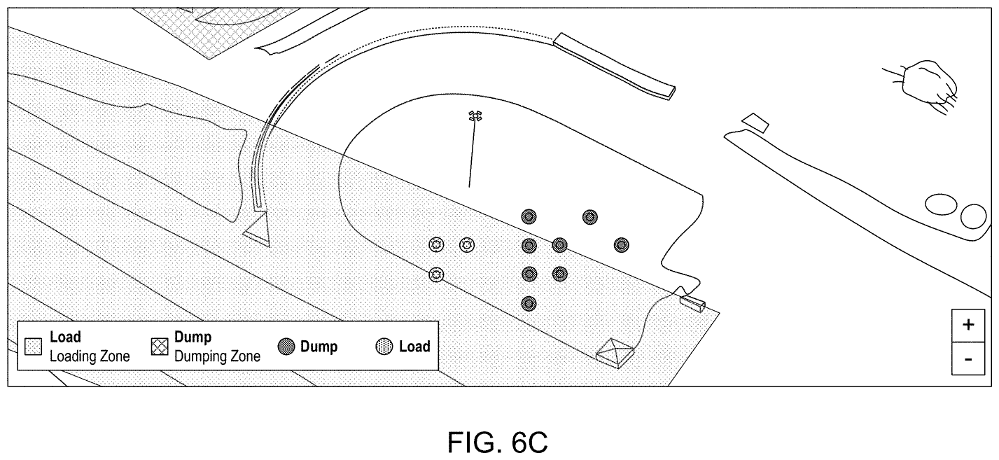

Having described the system and associated views, attention is now directed to operation of the disclosed system to provide enhanced productivity information based upon additional processing of production data points using the aforementioned supplemental production data 240. FIG. 7 provides a set of operations that are carried out by, for example, the production event data processing system 170 to render a temporal production status (productivity state) on a production data point for purposes of generating productivity metrics for a production asset cycle of the source asset of the production data point. During 700, the production event processing system acquires a production data point associated with a mobile asset. For example, the processing system 170 acquires a production data point from the database server 160. The production data point includes a temporal instance data including: a timestamp, a geospatial location, and an asset identification corresponding to the mobile asset.

During 710, the processing system 170 assigns a temporal production status to the data point based upon the temporal instance data and a supplemental production data. Such supplemental production data includes any one or more of: a current zone (described above) within a worksite occupied by the mobile asset, wherein the current zone is determined by applying the geospatial location (of the data point) to a user-defined worksite zone definition comprising a set of non-overlapping geospatially defined zones within the worksite; a machine state reported by the mobile asset (via the supplemental data 240 in the message from the asset); and a time-correlated production cycle-segment status of a further mobile asset interacting with the mobile asset.

Regarding the use of the current zone, in accordance with the disclosure, the processing system 170 may determine that a particular location falls within an “exemption” zone and accordingly not count a time span including the production data point in any segment time duration calculation (i.e. suspend the timer while the mobile asset is determined to be within the exemption zone). This is one example, of many potential uses of zone information to enhance the quality and precision of productivity metrics generated by the processing system 170.

Regarding the use of the machine state reported by the mobile asset, in accordance with the disclosure, additional (potentially user-defined data types) data (e.g., that is passed via the supplemental data 240 within production data points provided by the mobile asset to the worksite computer system 140) is processed by the processing system 170 to establish an operating status of the mobile asset. For example, a load weight sensor may be provided in the data point structure that indicates (over the course of several temporally sequential data points) that no loading was occurring for an extended period of time—indicating that the hauler truck 122 was not being serviced while positioned in a location associated with loading activity (a normally productive time period). Such inactivity may arise from a breakdown of coordinating operating machine assets (e.g. the bucket loader 126). In any event, such non-productivity is flagged by the additional information provided by the on-board weight sensor data provided in the supplemental data 240. This is merely one example, other examples include whether an engine, actuator, tool, etc. is turned on.

Regarding the use of a time-correlated production cycle-segment status of a further mobile asset interacting with the mobile asset, a further way in which the supplemental production data may be used to enhance productivity metric determination is to view the current segments within which a cooperating mobile asset is operating. For example, the hauler truck 122 may be located in an area of and in proximity to the bucket loader 126. However, according to the segment cycle data of the bucket loader 126, the loader 126 is not cycling through its segments—indicating that the bucket loader may be temporarily disabled. Such indication may result in the hauler truck 122 loading segment being suspended until operation of the bucket loader 126 resumes.

While the above discussion is focused upon the processing of a single point, it will be readily understood that such processing is aggregated over processing a sequential series of such production data points over an extended period of time to build segments and cycles of mobile asset operation in accordance with the disclosure.

With regard to specific example, the supplemental production data comprises the machine state reported by the mobile asset, and the temporal production status is one of the group consisting of the group consisting of: a load status, and a dump status. Moreover, in a particular example, the machine state is an engine operating state. In yet another example, the machine state is a load actuator state.

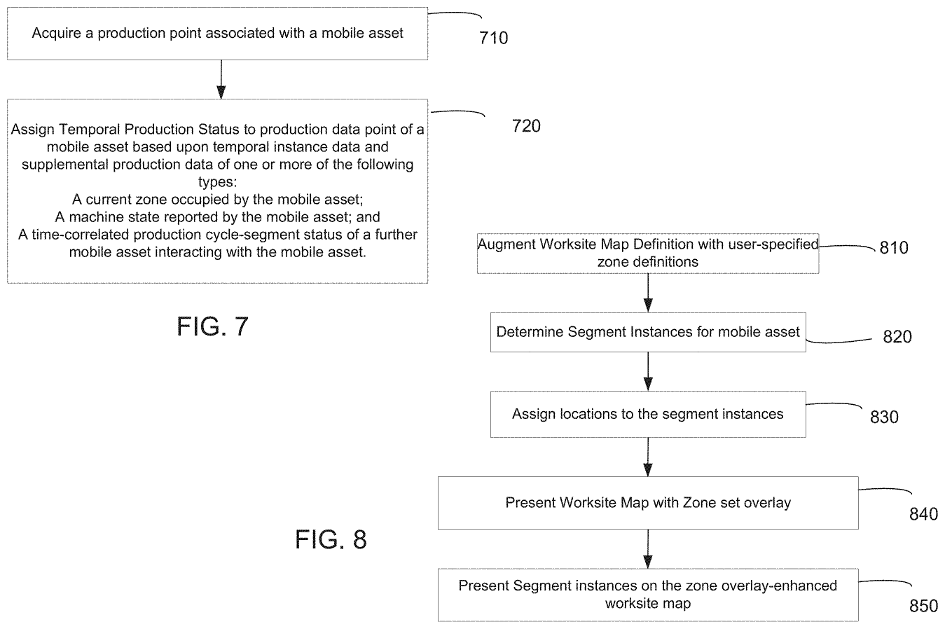

Turning to FIG. 8, flowchart summarizes a set of operations associated with visualizing (per FIGS. 6A, 6B and 6C) aggregated production events for a mobile asset operated within a repeating production cycle comprising a plurality of serially connected segments. During 810 a worksite graphical interface definition is augmented by providing a user-defined worksite zone definition (see FIG. 4) comprising a set of non-overlapping geospatially defined zones within the worksite. Thereafter, the system disclosed herein accumulates a set of production data points associated with the mobile asset, wherein one or more of the set of production data points comprise a temporal instance data including: a timestamp, a geospatial location, and an asset identification corresponding to the mobile asset.

During 820 the system determines a set of segment event instances from the set of production data points. Each one of the set of segment event instances is assigned a segment type (e.g. load, dump, traveling empty, traveling full, etc.) from a set of segment types represented in the repeated production cycle.

During 830 the system assigns a segment event location to one or more of the set of segment event instances. Such location assignment can apply to segments where the mobile asset is relatively stationary (e.g. loading, unloading, waiting).

During 840 the system presents a site map of the worksite overlaid with the set of non-overlapping geospatially defined zones. During 850 the system presents the set of segment event instances, according to the assigned segment event locations, on the site map of the worksite. Attention, in that regard is directed to FIGS. 6A, 6B and 6C showing both segment type counts and individual segment instances on a worksite image overlaid with the user-specified zones.

In accordance with particular examples of the disclosed system, the system also generates and presents a segment type-specific count corresponding to a group of segment event instances of a segment instance type having segment event location falling within a first zone of the set of non-overlapping geospatially defined zones of the site map. The system simultaneously presents both: a visual indicator of the first zone on the site map; and a numerical indicator of the segment type-specific count, on the site map, within the first zone on the site map.

In accordance with particular examples of the generation and presentation operations discussed herein above with reference to FIGS. 6A, 6B, 6C and 8, the segment type-specific count includes instances of a same segment instance type that are located within a same location of the first zone.

In accordance with particular examples of the generation and presentation operations discussed herein above with reference to FIGS. 6A, 6B, 6C and 8, the system generates a total count value of all instances of a same segment instance type that are located within the first zone and displays the total count value.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I/We claim:

1. A method for monitoring productivity metrics for a production cycle, the method comprising:
configuring a user-defined worksite zone definition comprising a set of non-overlapping geospatially defined zones within a worksite;
accumulating a set of production data points associated with a mobile asset, wherein one or more of the set of production data points comprise temporal instance data including:
a timestamp,
a geospatial location, and
an asset identification corresponding to the mobile asset;
assigning a temporal production status to the one or more of the set of production data points based upon the temporal instance data and at least one of a supplemental production data taken from a group consisting of:
a current zone within the worksite occupied by the mobile asset,
a machine state reported by the mobile asset, and
a time-correlated production cycle-segment status of a further mobile asset interacting with the mobile asset;
determining a set of segment event instances from the set of production data points, wherein one or more of the set of segment event instances is assigned a segment instance type;
assigning a segment event location to one or more of the set of segment event instances;
presenting a site map of the worksite overlaid with the set of non-overlapping geospatially defined zones; and
presenting the set of segment event instances, according to the assigned segment event location, on the site map of the worksite.

2. The method of claim 1, wherein the current zone is determined by applying the geospatial location to the user-defined worksite zone definition comprising the set of non-overlapping geospatially defined zones within the worksite.

3. The method of claim 1 further comprising:
generating a segment type-specific count corresponding to the set of segment event instances of the segment instance type having the segment event location within a first zone of the set of non-overlapping geospatially defined zones of the site map; and
simultaneously presenting:
a visual indicator of the first zone on the site map; and
a numerical indicator of the segment type-specific count, on the site map, within the first zone on the site map.

4. The method of claim 3 wherein the segment type-specific count includes instances of the segment instance type that are located within a location of the first zone.

5. The method of claim 3 further comprising:
generating a total count value of instances of the segment instance type that are located within the first zone; and
displaying the total count value.

6. The method of claim 1, wherein the supplemental production data comprises the machine state reported by the mobile asset, and wherein the temporal production status is a load status or a dump status.

7. The method of claim 6, wherein the machine state is an engine operating state or a load actuator state.

8. A computing system comprising:
one or more processors; and
one or more memories storing instructions that, when executed by the one or more processors, cause the computing system to perform a process comprising:
configuring a user-defined worksite zone definition comprising a set of non-overlapping geospatially defined zones within a worksite;
accumulating a set of production data points associated with a mobile asset, wherein one or more of the set of production data points comprise temporal instance data including:
a timestamp,
a geospatial location, and
an asset identification corresponding to the mobile asset;
assigning a temporal production status to the one or more of the set of production data points based upon the temporal instance data and at least one of a supplemental production data taken from a group consisting of:
a current zone within the worksite occupied by the mobile asset,
a machine state reported by the mobile asset, and
a time-correlated production cycle-segment status of a further mobile asset interacting with the mobile asset;
determining a set of segment event instances from the set of production data points, wherein one or more of the set of segment event instances is assigned a segment instance type;
assigning a segment event location to one or more of the set of segment event instances;
presenting a site map of the worksite overlaid with the set of non-overlapping geospatially defined zones; and
presenting the set of segment event instances, according to the assigned segment event location, on the site map of the worksite.

9. The computing system of claim 8, wherein the current zone is determined by applying the geospatial location to the user-defined worksite zone definition comprising the set of non-overlapping geospatially defined zones within the worksite.

10. The computing system of claim 8, wherein the process further comprises:
generating a segment type-specific count corresponding to the set of segment event instances of the segment instance type having the segment event location within a first zone of the set of non-overlapping geospatially defined zones of the site map; and
simultaneously presenting:
a visual indicator of the first zone on the site map; and
a numerical indicator of the segment type-specific count, on the site map, within the first zone on the site map.

11. The computing system of claim 10, wherein the segment type-specific count includes instances of the segment instance type that are located within a location of the first zone.

12. The computing system of claim 10, wherein the process further comprises:
generating a total count value of instances of the segment instance type that are located within the first zone; and
displaying the total count value.

13. The computing system of claim 8, wherein the supplemental production data comprises the machine state reported by the mobile asset, and wherein the temporal production status is a load status or a dump status.

14. The computing system of claim 13, wherein the machine state is an engine operating state or a load actuator state.

15. A machine-readable storage medium having machine executable instructions stored thereon that, when executed by one or more processors, direct the one or more processors to perform a method comprising:
configuring a user-defined worksite zone definition comprising a set of non-overlapping geospatially defined zones within a worksite;
accumulating a set of production data points associated with a mobile asset, wherein one or more of the set of production data points comprise temporal instance data including:
a timestamp,
a geospatial location, and
an asset identification corresponding to the mobile asset;
assigning a temporal production status to the one or more of the set of production data points based upon the temporal instance data and at least one of a supplemental production data taken from a group consisting of:
a current zone within the worksite occupied by the mobile asset,
a machine state reported by the mobile asset, and
a time-correlated production cycle-segment status of a further mobile asset interacting with the mobile asset;
determining a set of segment event instances from the set of production data points, wherein one or more of the set of segment event instances is assigned a segment instance type;
assigning a segment event location to one or more of the set of segment event instances;
presenting a site map of the worksite overlaid with the set of non-overlapping geospatially defined zones; and
presenting the set of segment event instances, according to the assigned segment event location, on the site map of the worksite.

16. The machine-readable storage medium of claim 15, wherein the current zone is determined by applying the geospatial location to the user-defined worksite zone definition comprising the set of non-overlapping geospatially defined zones within the worksite.

17. The machine-readable storage medium of claim 15, wherein the method further comprises:
generating a segment type-specific count corresponding to the set of segment event instances of the segment instance type having the segment event location within a first zone of the set of non-overlapping geospatially defined zones of the site map; and
simultaneously presenting:
a visual indicator of the first zone on the site map; and
a numerical indicator of the segment type-specific count, on the site map, within the first zone on the site map.

18. The machine-readable storage medium of claim 17, wherein the segment type-specific count includes instances of the segment instance type that are located within a location of the first zone.

19. The machine-readable storage medium of claim 17, wherein the method further comprises:
generating a total count value of instances of the segment instance type that are located within the first zone; and
displaying the total count value.

20. The machine-readable storage medium of claim 15, wherein the supplemental production data comprises the machine state reported by the mobile asset, and wherein the temporal production status is a load status or a dump status.
